(19) United States
(12) Patent Application Publication
(10) Pub. No.: US 2009/0235272 A1
(43) Pub. Date: Sep. 17, 2009

(54) DATA PROCESSING APPARATUS, DATA PROCESSING METHOD, AND RECORDING MEDIUM

(75) Inventor: Tadashi NAKANO, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/398,719

(22) Filed: Mar. 5, 2009

(30) Foreign Application Priority Data
Mar. 17, 2008 (JP) 2008-68530
Oct. 31, 2008 (JP) 2008-282478

(51) Int. Cl. G06F 13/00; G06F 1/32; G06F 9/46

(52) U.S. Cl. 718/105; 710/316; 713/320

(57) ABSTRACT

A data processing apparatus includes a plurality of devices and a switch including each port connecting each device. The switch includes a switching part including a data transmitting-receiving part transmitting or receiving data with processing function information identifying a subsequent data processing, a port table storing the subsequent data processing performed by the device and a load state of the device. A data relaying part referring to the port table to select a port number corresponding to the device having a lowest load from among the port numbers and relaying the data to the device corresponding to the port having the selected port number. Each device includes a processing function part which performs data processing to the relayed data in a given order according to the processing function information added to the data, and transmitting the data with the processing function information.

### CROSS-REFERENCE TO RELATED APPLICATIONS

This application is based upon and claims the benefit of priorities of the prior Japanese Patent Application No. 2008-282478 filed on Oct. 31, 2008 and the prior Japanese Patent Application No. 2008-68530 filed on Mar. 17, 2008, the entire contents of which are incorporated herein by reference.

### FIELD

The embodiments discussed herein are related to a data processing apparatus, a data processing method, and a recording medium storing a data processing program recorded thereon.

### BACKGROUND

Each of data processing apparatuses, such as boards conforming to Advanced Telecom Computing Architecture (ATCA), including multiple devices to perform data processing is conventionally used. Such a data processing apparatus selects one device from the devices to which substantially the same processing function is allocated to process a large amount of data at high speed.

For example, a data processing apparatus may include a device group α including devices A, B, C, and D that perform encryption processing, a device group β including devices E, F, G, and H that perform encoding processing, and a device Z that receives and returns a data packet from and to a requester of the data processing. The data processing apparatus includes a plurality of ports and a switch (for example, a L2-layer switch) that performs relay of data packets between the devices. Each of the plurality of ports corresponds to each device.

Japanese Unexamined Patent Application Publication No. 2007-26184 discusses a round robin method for processing distribution in accordance with a load (for example, an operating rate of a central processing unit (CPU)) as methods of selecting a device used by such a data processing apparatus.

FIG. 22A and FIG. 22B illustrate examples of exemplary process(es) in a data processing apparatus in prior art. First, an example of a data processing apparatus using the round robin method will be described. Referring to FIG. 22A, in Operation 1, after completing the reception processing of a data packet, the device Z sequentially selects a device from the device group a in a specific order each time the device Z receives a data packet from the requester of the data processing and transmits the data packet to the selected device. For example, the devices A, B, C, D, A, B, . . . are sequentially selected in this order.

In Operation 2, each time the device A receives the data packet from the device Z and performs the encryption processing, the device A sequentially selects a device from the device group β in a specific order and transmits the data packet to the selected device. For example, the devices E, F, G, H, E, F, . . . are sequentially selected in this order.

After the device E receives the data packet from the device A and performs the encoding processing, the device E transmits the data packet to the device Z. Then, the device Z returns the data packet to the requester of the data processing.

Next, an example of a data processing apparatus using the method for processing distribution in accordance with a load will be described. The data processing apparatus using the method for processing distribution in accordance with a load further includes a micro processing unit (MPU). The micro processing unit monitors the load states of all the-devices and notifies all the devices of the results of the monitoring of the devices. The MPU serves as a processor for monitoring.

In this configuration, referring to FIG. 22B, in Operation 1, after completing the reception processing of a data packet, the device Z selects a device (for example, the device A) having the lowest load from the device group cc on the basis of the result of the monitoring notified by the MPU. The device Z transmits the data packet to the selected device.

In Operation 2, after the device A receives the data packet from the device Z and performs the encryption processing, the device A selects a device (for example, the device E) having the lowest load from the device group β on the basis of the result of the monitoring notified by the MPU. The device A transmits the data packet to the selected device.

After the device E receives the data packet from the device A and performs the encoding processing, the device E transmits the data packet to the device Z. Then, the device Z returns the data packet to the requester of the data processing.

### SUMMARY

According to an aspect of an embodiment, a data processing apparatus includes each data processing part in each of the a plurality of devices performing a data processing in a given order and a switch.

A switching part in the switch includes a data transmitting-receiving part receiving data with processing function information identifying a data processing to be subsequently performed from other data processing apparatus, transmitting data or receiving data to or from one of the devices via a corresponding port, and transmitting processed data to the other data processing apparatus, a port table storing the processing function information for identifying the data processing performed by the device corresponding to each port and a load state that is updated in accordance with an operational status of the device corresponding to each port in association with a port number identifying each port. A switching part according to an embodiment includes a data relaying part referring to the port table at reception of data from one of the devices to select the port number corresponding to the device having a lowest load from among the port numbers to which the processing function information added to the received data is allocated and relaying the data to the device corresponding to the port having the selected port number.

Each processing function part in the plurality of the devices includes a data processing part performing data processing to the relayed data in a given order according to the processing function information, a functional-header adding part adding processing function information to the processed data, and a data transmitting part transmitting the data with the processing function information.

### BRIEF DESCRIPTION OF THE DRAWINGS

FIG. 1 illustrates the outline and features of a data processing apparatuses according to an embodiment;

FIG. 2 is a block diagram illustrating an example of a configuration of a data processing apparatus according to an embodiment;

FIG. 3 is a block diagram illustrating an example of a configuration of a device in an embodiment;

FIGS. 4A, 4B and 4C illustrate processing performed by a functional-header adding part in an embodiment;

FIG. 5 is a block diagram illustrating an example of a configuration of a switch and a port in an embodiment;

FIG. 6 illustrates an example of information stored in a port table in an embodiment;

FIG. 7 is an operation chart illustrating an example of a process performed by a device in an embodiment;

FIG. 8 is an operation chart illustrating an example of a process performed by a port in an embodiment;

FIG. 9 is a block diagram illustrating an example of a configuration of a device in an embodiment;

FIG. 10 is a block diagram illustrating an example of a configuration of a switch and a port in an embodiment;

FIG. 11 illustrates an example of information stored in a port table in an embodiment;

FIG. 12 is an operation chart illustrated as an example of a process performed by a port in an embodiment;

FIG. 13 is a block diagram illustrating an example of a configuration of a device in an embodiment;

FIG. 14 is a block diagram illustrating an example of a configuration of a switch and a port in an embodiment;

FIGS. 15A, 15B, and 15C illustrate an example of processing performed by a port-table update processing part in an embodiment;

FIG. 16 is an operation chart illustrating an example of a process performed by a device in an embodiment;

FIG. 17 is an operation chart illustrating an example of a process performed by a port in an embodiment;

FIG. 18 is a block diagram illustrating an example of a configuration of a data processing apparatus according to an embodiment;

FIG. 19 illustrates an example of information stored in a port table in an embodiment;

FIG. 20 is an operation chart illustrating an example of a process performed by a data processing apparatus according to an embodiment;

FIG. 21 illustrates an example of a configuration of a computer executing a data processing program; and

FIG. 22A and FIG. 22B illustrate examples of exemplary processes in a data processing apparatus in prior art.

The object and advantages of the embodiment discussed herein will be realized and attained by means of elements and combinations particularly pointed, out in the claims.

It is to be understood that both the foregoing general description and the following detailed and the following detailed description are exemplary and only are not restrictive exemplary explanatory are not restrictive of the invention, as claimed.

### DETAILED DESCRIPTION OF EMBODIMENTS

The embodiments discussed herein are related to data processing apparatuses, a data processing method, and data processing program(s) will herein be described in detail with reference to the attached drawings. A data processing apparatus (for example, an ATCA board) to which the embodiment(s) discussed herein are applied is exemplified in the following description.

### First Embodiment

Keywords used in the embodiments, outline and feature(s) of a data processing apparatuses according to embodiments, an example of the configuration of the data processing apparatus according to the embodiments, an exemplary process performed by the data processing apparatus according to the embodiments, and the advantages of the embodiments are sequentially described below.

The keywords used in the embodiments will now be described. “Processing function information” refers to information (functional header) identifying a data processing performed by each device. For example, if the data processing apparatus is set so as to perform reception, encryption, encoding, and return processing of data received from a requester of the data processing and to return the data to the requester of the data processing, the encryption processing corresponds to processing function information “No. 1”, the encoding processing corresponds to processing function information “No. 2”, and the return processing corresponds to processing function information “End”. The structure of the processing function information does not identify the present invention and the processing function information may be any information represented by a signal of one byte.

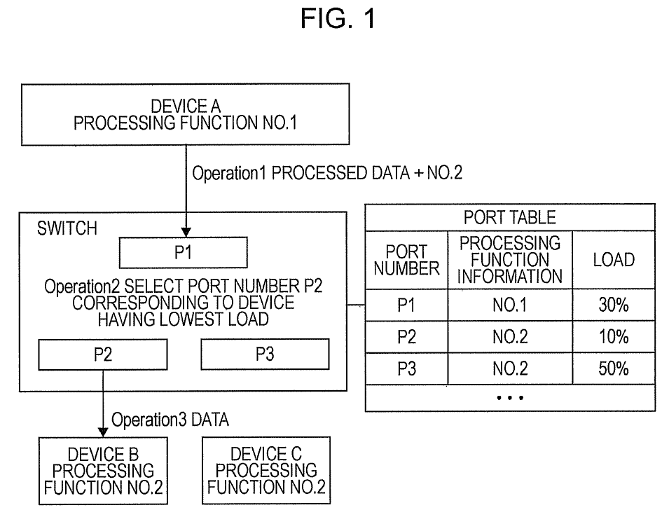

FIG. 1 illustrates an outline and features of a data processing apparatus according to an embodiment.

The data processing apparatus according to an embodiment includes multiple devices (for example, devices A, B, and C) performing data processing and a switch relaying data between the devices via ports (for example, ports P1, p2, and P3) corresponding to all the devices.

The data processing apparatus according to an embodiment causes the multiple devices to sequentially perform the data processing in a given order. The data processing apparatus is characterized by improving the processing efficiency as the data processing apparatus.

For example, the switch in the data processing apparatus according to an embodiment includes a port table that stores the processing function information and a load in association with the port number identifying each port. The processing function information identifies the data processing performed by the device corresponding to each port. The load is updated in accordance with the operational status of the device corresponding to each port.

In this configuration, for example, after the device A to which the processing function corresponding to the processing function information “No. 1” is allocated performs the data processing to data that is received, the device A transmits processed data to which the processing function information “No. 2” identifying the data processing to be performed subsequent to the data processing completed by the device A is added to the switch, as illustrated in Operation 1 in FIG. 1.

The switch, which has received the data from the device A, refers to the port table to select the port number (for example, the port number “P2”) corresponding to the device having the lowest load from among the port numbers to which the processing function information “No. 2” added to the received data is allocated, as illustrated in Operation 2 in FIG. 1.

The switch relays the data to the device B corresponding to the port having the port number “P2”, as illustrated in Operation 3 in FIG. 1.

The data processing apparatus according to an embodiment is capable of improving the processing efficiency as the data processing apparatus in the manner described above.

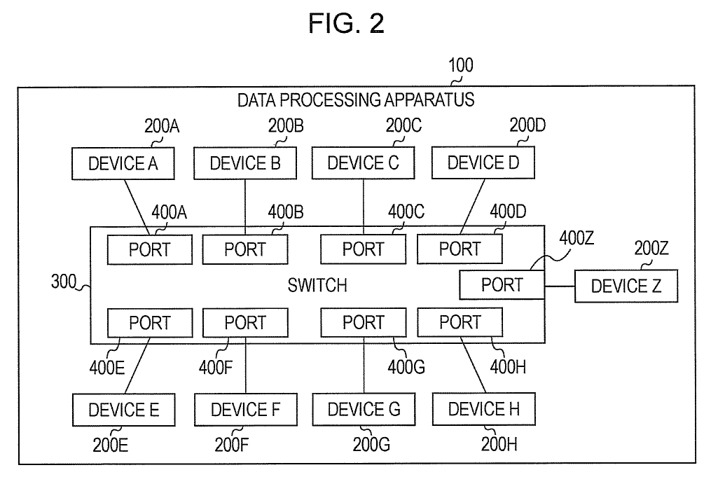

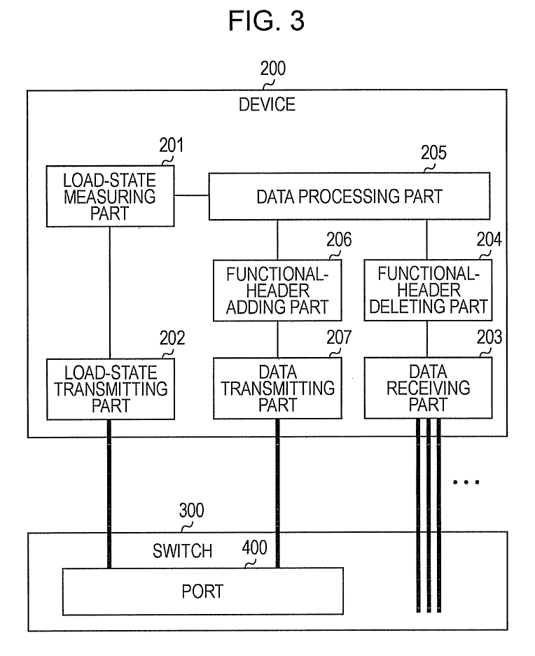

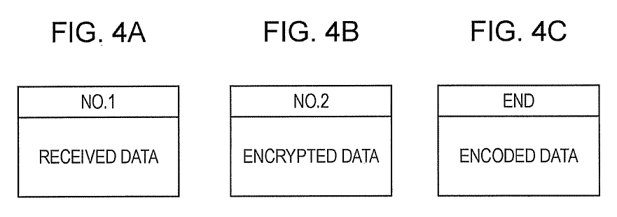

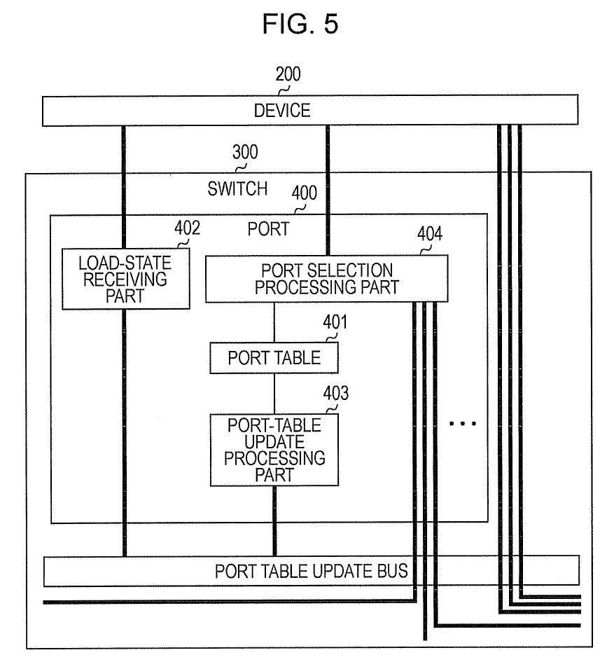

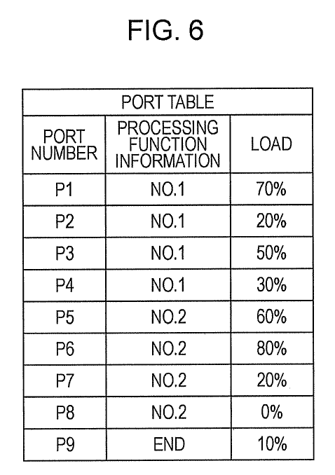

An example of the configuration of the data processing apparatus according to an embodiment is described with reference to FIGS. 2 to 6. FIG. 2 is a block diagram illustrating an example of a configuration of a data processing apparatus according to an embodiment. FIG. 3 is a block diagram illustrating an example of a configuration of a device in an embodiment. FIGS. 4A, 4B and 4C illustrate a processing performed by a functional-header adding part. FIG. 5 is a block diagram illustrating an example of a configuration of a switch and a port in an embodiment. FIG. 6 illustrates an example of information stored in a port table in an embodiment.

Referring to FIG. 2, a data processing-apparatus 100 includes devices 200A to 200H, a device 200Z, and a switch 300. For ease of explanation, the devices 200A to 200H and the device 200Z are collectively referred to as a device 200. Ports 400A to 400H and a port 400Z in the switch 300 correspond to the device 200A to 200H and the device Z, respectively. For example, the port 400A corresponds to the device 200A. For ease of explanation, the ports 400A to 400H and the port 400Z are collectively referred as a port 400. The devices 200A to 200H and the device 200Z are represented as the devices 200A to 200H and 200Z. Substantially the same applies to the ports 400A to 400H and the port 400Z.

The device 200 corresponds to, for example, a CPU and performs data processing(s) that is allocated. The devices 200A to 200H and 200Z may substantially have the same configuration and perform substantially the same processing except that the devices 200A to 200D perform an encryption processing, the devices 200E to 200H perform an encoding processing, and the device 200Z receives and returns a data packet from and to the requester of the data processing.

Referring to FIG. 3, the device 200 includes a load-state measuring part 201, a load-state transmitting part 202, a data receiving part 203, a functional-header deleting part 204, a data processing part 205, a functional-header adding part 206, and a data transmitting part 207. Unless otherwise indicated, a “data transmitting part” in the claims particularly relates to the functional-header adding part 206.

The load-state measuring part 201 measures a load state of each device. For example, the load-state measuring part 201 monitors the data processing part 205. The load-state measuring part 201 measures the load (for example, an operating rate of 70%) of the data processing part 205 on the basis of a length of a time during which the data processing part 205 performs a data processing and a length of a time during which the data processing part 205 does not perform the data processing and supplies a measured load to the load-state transmitting part 202.

The load-state transmitting part 202 transmits the load received from the load-state measuring part 201 to the port 400 corresponding to the device 200. For example, a bus (a bold line) connected to the load-state transmitting part 202 in the device 200A is connected to a load-state receiving part 402 described below in the port 400A.

The data receiving part 203 receives data communicated between the devices. For example, the data receiving part 203 supplies a data packet received from the port 400 to the functional-header deleting part 204. For example, each bus connected to the data receiving part 203 in the device 200A is connected to a port selection processing part 404 described below in each of the ports 400B to 400H and 400Z.

The functional-header deleting part 204 deletes the processing function information added to the data. For example, the functional-header deleting part 204 deletes the processing function information (functional header) from the data packet received from the data receiving part 203 and supplies the data included in the data packet to the data processing part 205.

The data processing part 205 performs the data processing allocated to the device 200. For example, the data processing part 205 performs the encryption processing (or the transmission and reception processing or the encoding processing) with respect to the data received from the functional-header deleting part 204. Then, the data processing part 205 supplies the processed data to the functional-header adding part 206.

The functional-header adding part 206 adds the processing function information identifying the data processing to be subsequently performed to the processed data. For example, the functional-header adding part 206 adds the processing function information identifying the data processing to be performed subsequent to the data processing performed by the data processing part 205 to the processed data received from the data processing part 205, as illustrated in FIG. 4A, 4B, or 4C, to generate a data packet. The functional-header adding part 206, then, supplies the generated data packet to the data transmitting part 207.

For example, if the functional-header adding part 206 in the device 200Z receives the data subjected to reception processing from the data processing part 205, the functional-header adding part 206 adds the processing function information “No. 1” identifying the encryption processing to the data subjected to the reception processing to generate a data packet, as illustrated in FIG. 4A.

If the functional-header adding part 206 in any of the devices 200A to 200D receives the data subjected to the encryption processing from the data processing part 205, the functional-header adding part 206 adds the processing function information “No. 2” identifying the encoding processing to the data subjected to the encryption processing to generate a data packet, as illustrated in FIG. 4B.

If the functional-header adding part 206 in any of the devices 200E to 200H receives the data subjected to the encoding processing from the data processing part 205, the functional-header adding part 206 adds the processing function information “End” identifying the return processing to the data subjected to the encoding processing to generate a data packet, as illustrated in FIG. 4C.

The data transmitting part 207 transmits the data packet received from the functional-header adding part 206 to the port 400 corresponding to the device 200. For example, a bus connected to the data transmitting part 207 in the device 200A is connected to the port selection processing part 404 described below in the port 400A.

Referring to FIG. 5, the port 400 includes a port table 401, a load-state receiving part 402, a port-table update processing part 403, and a port selection processing part 404. Unless otherwise indicated, a “port table” in the claims particularly relates to the port table 401 and a “data relaying part” in the claims particularly relates to the port selection processing part 404.

The port table 401 stores the processing function information identifying the data processing performed by the device 200 corresponding to the port 400 and the load updated in accordance with the operational status of the device 200 corresponding to the port 400 in association with the port number identifying each port 400, as illustrated in FIG. 6.

The port number and the processing function information are stored at a start of the operation of the data processing apparatus 100. The load is information that is appropriately updated by the port-table update processing part 403.

The load-state receiving part 402 transmits the load received from the device 200 corresponding to the port 400 to the other ports 400. For example, if the load-state receiving part 402 in the port 400A receives the load from the device 200A, the load-state receiving part 402 transmits the port number P1 of the port 400A and the load (for example, an operating rate of 70%) of the device 200A to a port-table update bus.

For example, each bus connected to the load-state receiving part 402 in the port 400A is connected to the load-state transmitting part 202 in the device 200A corresponding to the port 400A and to the port-table update bus.

For example, the port number P1 of the port 400A and the load (for example, 70%) of the device 200A, received from the load-state receiving part 402 in the port 400A, are transmitted to the port-table update processing part 403 in each of all the ports 400A to 400H and 400Z through the port-table update bus.

The port-table update processing part 403 updates the port table 401 in accordance with the operational status of the device 200. For example, when the port-table update processing part 403 receives the port number and the load from the port 400 through the port-table update bus, the port-table update processing part 403 updates a load corresponding to the port number stored in the port table 401.

For example, a bus connected to the port-table update processing part 403 in the port 400A is connected to the load-state receiving part 402 in each of all the ports 400A to 400H and 400Z via the port-table update bus.

At reception of data from the device 200, the port selection processing part 404 refers to the port table 401 to select the port number corresponding to the device 200 having the lowest load from among the port numbers to which the processing function information added to the received data is allocated and relays the data to the device 200 corresponding to the port 400 having the selected port number.

For example, if the port selection processing part 404 in the port 400Z receives a data packet from the device 200Z, the port selection processing part 404 reads out the processing function information “No. 1” added to the data subjected to the reception processing. Next, the port selection processing part 404 in the port 400Z refers to the port table 401 to select the port number P2 corresponding to the device 200B, having the lowest load, from among the port numbers (P1 to P4 (refer to FIG. 6)) corresponding to the processing function information “No. 1”. Then, the port selection processing part 404 in the port 400Z relays the data to the device 200B corresponding to the port number P2.

If the port selection processing part 404 in any of the ports 400A to 400D receives a data packet from the corresponding device 200A, 200B, 200C, or 200D, the port selection processing part 404 reads out the processing function information “No. 2” added to the data subjected to the encryption processing. Next, the port selection processing part 404 in any of the ports 400A to 400D refers to the port table 401 to select the port number P8 corresponding to the device 200H, having the lowest load, from among the port numbers (P5 to P8 (refer to FIG. 6)) corresponding to the processing function information “No. 2”. Then, the port selection processing part 404 in any of the ports 400A to 400D relays the data to the device 200H corresponding to the port number P8.

If the port selection processing part 404 in any of the ports 400E to 400H receives a data packet from the corresponding device 200E, 200F, 200G, or 200H, the port selection processing part 404 reads out the processing function information “End” added to the data subjected to the encoding processing. Next, the port selection processing part 404 in any of the ports 400E to 400H refers to the port table 401 to select the port number P9 corresponding to the processing function information “End”. Then, the port selection processing part 404 in any of the ports 400E to 400H relays the data to the device 200Z corresponding to the port number P9.

For example, a bus extending from the port selection processing part 404 in the port 400A to the device 200A is connected to the data transmitting part 207 in the device 200A. Each bus that is connected to the port selection processing part 404 in the port 400A through the switch 300 is connected to the data receiving part 203 in each of the devices 200B to 200H and 200Z.

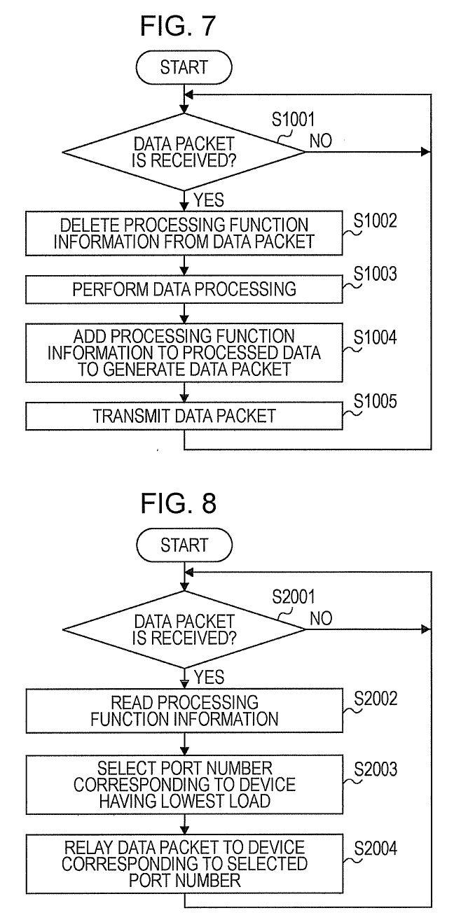

An exemplary process performed by the data processing apparatus 100 according to an embodiment is described. The data processing apparatus 100 according to an embodiment sequentially performs the reception processing, the encryption processing, the encoding processing, and the return processing to data received from the requester of the data processing. A process in which the device 200 receives a data packet from the port 400 and transmits the data packet to the port 400 will be described with reference to FIG. 7. A process in which the port 400 receives a data packet from the device 200 and relays the data packet to the other devices 200 will be described with reference to FIG. 8.

FIG. 7 is an operation chart illustrated an example of a process performed by a device in an embodiment. FIG. 8 is an operation chart illustrated as an example of a process performed by a port in an embodiment. The processes performed by the device 200 and the port 400 terminate when the operation of the data processing apparatus 100 is stopped.

Referring to FIG. 7, at S1001, the device 200, for example, determines whether a data packet is received from the port 400. If the device 200 determines that a data packet is received from the port 400 (YES at S1001), then at S1002, the device 200 deletes the processing function information from the data packet. At S1003, the device 200 performs the data processing allocated to the device 200.

At S1004, the device 200 adds the processing function information identifying the data processing to be subsequently performed to the processed data to generate a data packet. At S1005, the device 200 transmits the data packet to the port 400 corresponding to the device 200. Then, the process goes back to S1001 and the device 200 waits for reception of a data packet (NO at S1001).

Referring to FIG. 8, at S2001, the port 400, for example, determines whether a data packet is received from the device 200. If the port 400 determines that a data packet is received from the device 200 (YES at S2001), then at S2002, the port 400 reads out the processing function information added to the processed data. At S2003, the port 400 selects the port number corresponding to the device 200 having the lowest load from among the port numbers corresponding to the processing function information.

At S2004, the port 400 relays the data packet to the device 200 corresponding to the selected port number. Then, the process goes back to S2001 and the port 400 waits for reception of a data packet (NO at S2001).

As described above, according to an embodiment of a data processing apparatus, it is possible to improve the processing efficiency of the data processing apparatus. For example, the data processing apparatus according to an embodiment is capable of evenly distributing the load between the devices to which substantially the same processing function is allocated and of improving the processing capability of the data processing that should be performed by each device, thus improving the processing efficiency as the data processing apparatus.

### Second Embodiment

There are cases in which the data processing apparatus 100 according to an embodiment may not make the most of the processing capability as the data processing apparatus because data is transmitted to the device 200 that may not perform the data processing due to a failure, such as a program access error.

Accordingly, according to an embodiment of the present invention, selection of one device from among the devices 200 in which no failure occurs will be described. An example of a configuration of the data processing apparatus according to an embodiment of the present invention, an exemplary process performed by the data processing apparatus according to an embodiment, and the advantages of an embodiment will be sequentially described in an embodiment.

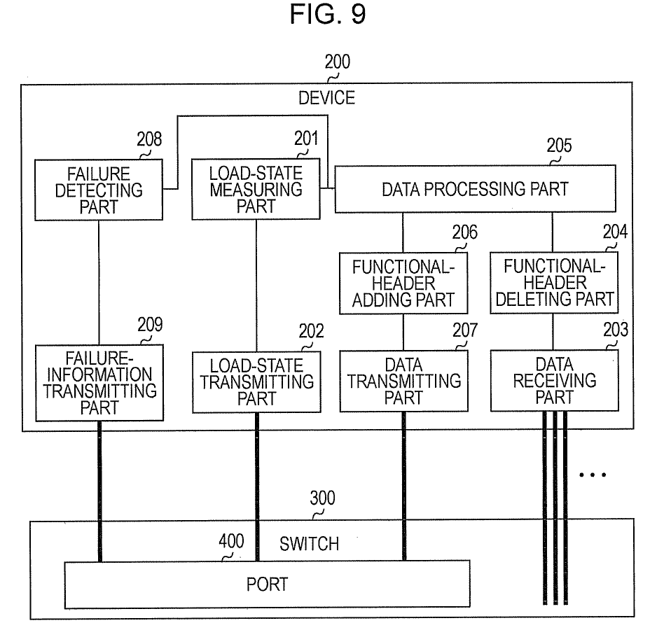

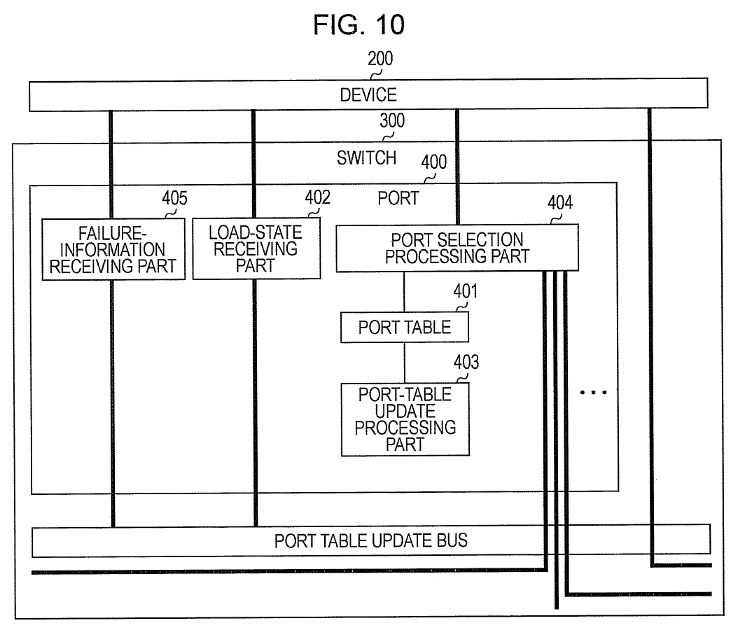

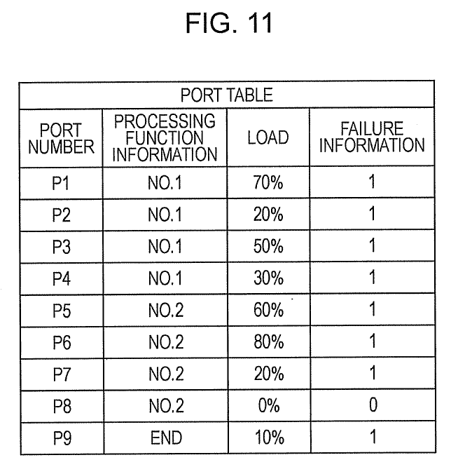

An example of the configuration of the data processing apparatus according to an embodiment is described with reference to FIGS. 9, 10, and 11. FIG. 9 is a block diagram illustrating an example of a configuration of a device in an embodiment. FIG. 10 is a block diagram illustrating an example of a configuration of a switch and a port in an embodiment. FIG. 11 illustrates an example of information stored in a port table in an embodiment.

The device 200 in an embodiment includes a failure detecting part 208 and a failure-information transmitting part 209, in addition to the components according to an embodiment illustrated in FIG. 3. The example of the configuration of the device 200 in an embodiment differs from that of the device 200 in an embodiment in the following manner.

Referring to FIG. 9, the failure detecting part 208 detects a failure of the device 200. For example, the failure detecting part 208 monitors the data processing part 205 and supplies failure information indicating that a failure occurs to the failure-information transmitting part 209 if the failure detecting part 208 detects an occurrence of a device failure or a software failure (for example, a program access error) in the data processing part 205.

The failure-information transmitting part 209 transmits the failure information received from the failure detecting part 208 to the port 400 corresponding to the device 200. For example, a bus connected to the failure-information transmitting part 209 in the device 200A is connected to a failure-information receiving part 405 described below in the port 400A.

The port 400 in an embodiment includes the failure-information receiving part 405, in addition to the components according to an embodiment illustrated in FIG. 5. The example of the configuration of the switch 300 and the port 400 in an embodiment differs from that of the switch 300 and the port 400 in an embodiment in the following manner.

Referring to FIG. 10, the port table 401 stores the failure information identifying a device where a failure occurs in association with the port number. For example, the port table 401 stores the processing function information, the load, and the failure information indicating whether a failure occurs in the device 200 in association with the port number of the port 400 corresponding to the device 200, as illustrated in FIG. 11.

The failure information is appropriately updated on an occurrence of a failure or on recovery from a failure. Failure information “1” indicates that no failure occurs in the device 200 and failure information “0” indicates that a failure occurs in the device 200.

The failure-information receiving part 405 transmits the failure information received from the device 200 corresponding to the port 400 to the other ports 400. For example, if the failure-information receiving part 405 in the port 400A receives the failure information from the device 200A, the failure-information receiving part 405 transmits the port number P1 of the port 400A and the failure information (“1” or “0”) about the device 200A to the port-table update bus.

For example, each bus connected to the failure-information receiving part 405 in the port 400A is connected to the failure-information transmitting part 209 in the device 200A and to the port-table update bus. For example, the port number P1 of the port 400A and the failure information about the device 200A, received from the failure-information receiving part 405 in the port 400A, are transmitted to the port-table update processing part 403 in each of all the ports 400A to 400H and 400Z through the port-table update bus.

At reception of the port number and the failure information from another port 400 through the port-table update bus, the port-table update processing part 403 updates the failure information corresponding to the port number stored in the port table 401. For example, if the port-table update processing part 403 receives the port number P1 of the port 400A and the failure information “0”, the port-table update processing part 403 updates the failure information corresponding to the port number P1 from “1” to “0”.

The port selection processing part 404 selects the port number that does not correspond to the failure information. For example, if the port selection processing part 404 in any of the ports 400A to 400D receives a data packet from the corresponding device 200A, 200B, 200C, or 200D, the port selection processing part 404 reads out the processing function information “No. 2” added to the data subjected to the encryption processing. The port selection processing part 404 in any of the ports 400A to 400D refers to the port table 401 to select the port numbers (P5 to P7) corresponding to the failure information “1” indicating that no failure occurs from among the port numbers (P5 to P8 (refer to FIG. 11)) corresponding to the processing function information “No. 2”.

Then, the port selection processing part 404 in any of the ports 400A to 400D selects the port number P7 corresponding to the device 200G having the lowest load from among the selected port numbers (P5 to P7). The port selection processing part 404 in any of the ports 400A to 400D relays the data to the device 200G corresponding to the port number P7.

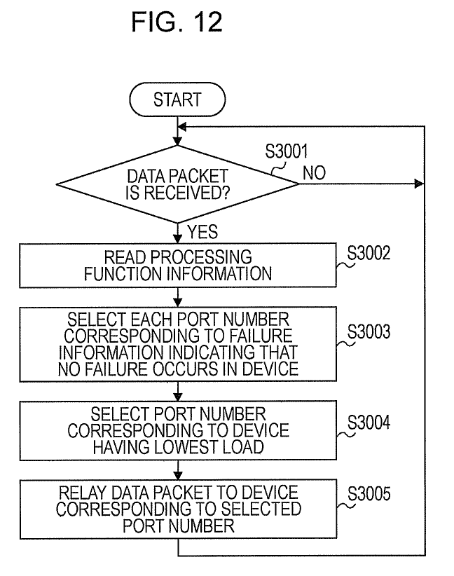

An exemplary process performed by the data processing apparatus according to an embodiment is described with reference to FIG. 12. A process in which the port 400 in the data processing apparatus according to an embodiment receives a data packet from the device 200 and relays the data packet to the other devices 200 will be described. FIG. 12 is an operation chart illustrated as an example of a process performed by a port in an embodiment.

Referring to FIG. 12, at S3001, the port 400, for example, determines whether a data packet is received from the device 200. If the port 400 determines that a data packet is received from the device 200 (YES at S3001), then at S3002, the port 400 reads out the processing function information added to the processed data. At S3003, the port 400 selects the port numbers corresponding to the failure information indicating that no failure occurs in the device from among the port numbers corresponding to the processing function information.

At S3004, the port 400 selects the port number corresponding to the device 200 having the lowest load from the selected port numbers.

At S3005, the port 400 relays the data packet to the device 200 corresponding to the selected port number. Then, the process goes back to S3001 and the device 400 waits for reception of a data packet (NO at S3001).

As described above, according to an embodiment of the data processing apparatus, it is possible to improve the processing efficiency of the data processing apparatus based on a determination of whether an occurrence of a failure in a device exists. For example, the data processing apparatus according to an embodiment is capable of improving the processing efficiency as the data processing apparatus based on an occurrence of a failure in a device because no data packet is transmitted to the device in which a failure occurs.

### Third Embodiment

The device 200 may be a so-called reconfigurable device capable of rewriting a program stored in a memory to change the processing function that is allocated.

According to an embodiment of the data processing apparatus, a case is described in which the reconfigurable device is applied to each of the devices 200A to 200H and 200Z in the data processing apparatus 100 according to an embodiment and the encryption processing allocated to the device 200A is changed to the encoding processing during the operation of the data processing apparatus 100. An example of the configuration of the data processing apparatus according to an embodiment of the present invention, an exemplary process performed by the data processing apparatus according to an embodiment.

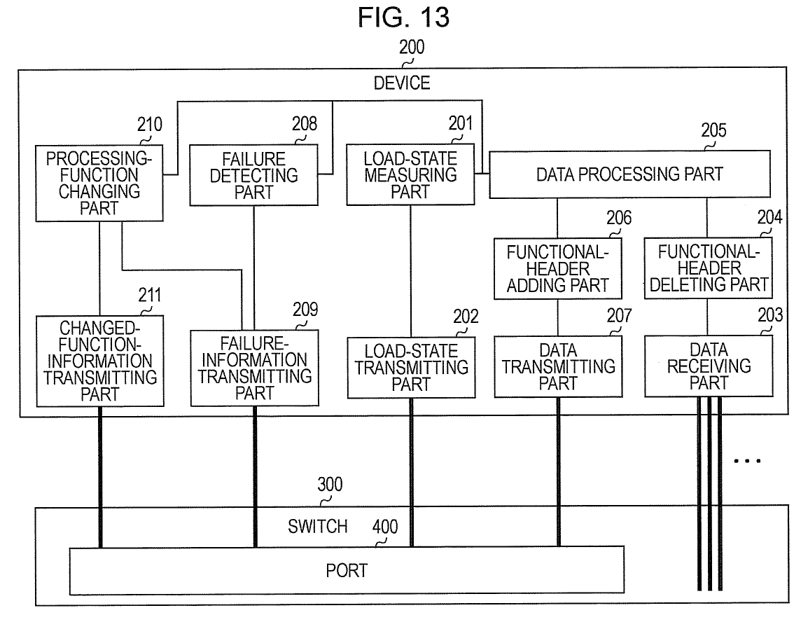

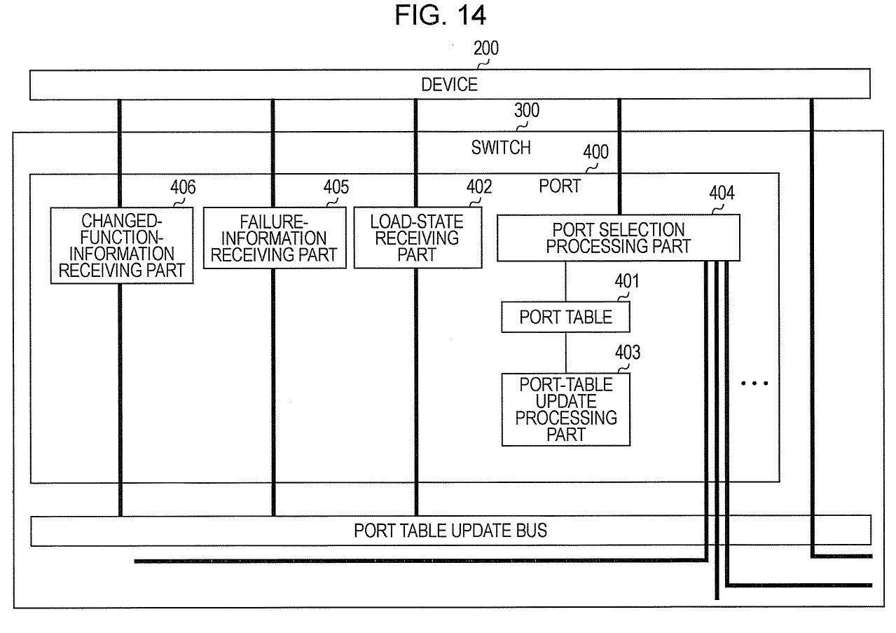

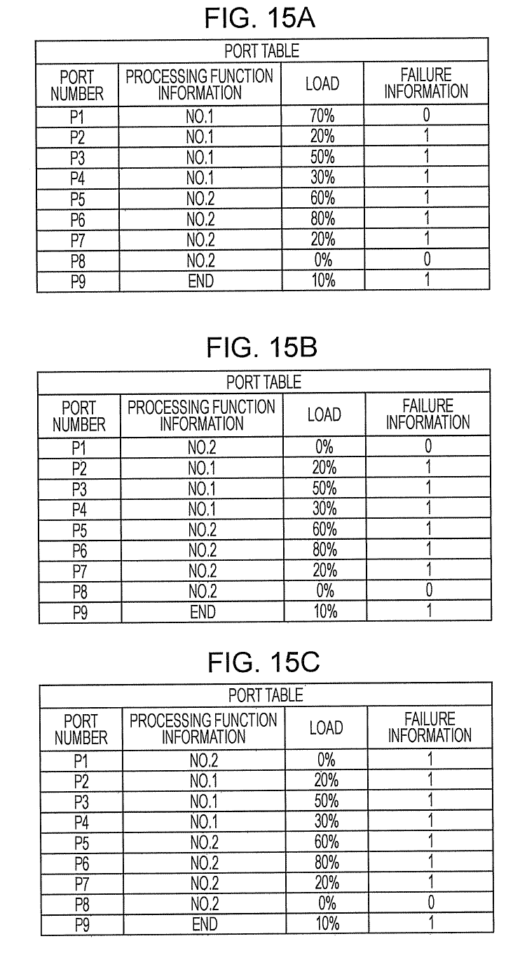

An example of a configuration of a data processing apparatus according to an embodiment is described with reference to FIGS. 13, 14 and FIGS. 15A to 15C. FIG. 13 is a block diagram illustrating an example of a configuration of a device in an embodiment. FIG. 14 is a block diagram illustrating an example of a configuration of a switch and a port in an embodiment. FIGS. 15A, 15B, and 15C illustrate an example of processing performed by a port-table update processing part in an embodiment.

The device 200 in an embodiment includes a processing-function changing part 210 and a changed-function-information transmitting part 211, in addition to the components according to an embodiment illustrated in FIG. 9. The example of the configuration of the device 200 in an embodiment differs from that of the device 200 in an embodiment in the following manner.

Referring to FIG. 9, the processing-function changing part 210 changes the processing function allocated to the device 200. For example, if the processing-function changing part 210 in the device 200A receives an encoding processing program as an instruction to change the function, the processing-function changing part 210 requests the failure-information transmitting part 209 to transmit “0” as the failure information indicating that a failure occurs.

Next, the processing-function changing part 210 deletes an encryption processing program stored in a memory in the data processing part 205, stores the encoding processing program in the memory in the data processing part 205, and supplies “No. 2” as the processing function information identifying the encoding processing to the changed-function-information transmitting part 211.

Then, the processing-function changing part 210 requests the failure-information transmitting part 209 to transmit “1” as the failure information indicating that no failure occurs.

When the failure-information transmitting part 209 receives the request to transmit the failure information from the processing-function changing part 210, the failure-information transmitting part 209 transmits “1” (or “0”) as the failure information to the port 400 corresponding to the device 200.

The changed-function-information transmitting part 211 transmits the processing function information received from the processing-function changing part 210 to the port 400 corresponding to the device 200. For example, a bus connected to the changed-function-information transmitting part 211 in the device 200A is connected to a changed-function-information receiving part 406 described below in the port 400A.

The port 400 in an embodiment includes the changed-function-information receiving part 406, in addition to the components according to an embodiment as illustrated in FIG. 10. The example of the configuration of the switch 300 and the port 400 in an embodiment differs from that of the switch 300 and the port 400 in an embodiment in the following manner. Unless otherwise indicated, “processing-function-information updating part” in the claims particularly relates to the port-table update processing part 403 according to an embodiment.

Referring to FIG. 14, the changed-function-information receiving part 406 transmits changed function information received from the device 200 corresponding to each port 400 to the other ports 400. For example, if the changed-function-information receiving part 406 in the port 400A receives “No. 2” as the processing function information identifying the encoding processing from the device 200A, the changed-function-information receiving part 406 transmits the port number P1 of the port 400A and “No. 2” as the processing function information identifying the encoding processing to the port-table update bus.

For example, each bus connected to the changed-function-information receiving part 406 in the port 400A is connected to the changed-function-information transmitting part 211 in the device 200A corresponding to the port 400A and to the port-table update bus. For example, the port number P1 of the port 400A and “No. 2” as the processing function information identifying the encoding processing, received from the changed-function-information receiving part 406 in the port 400A, are transmitted to the port-table update processing part 403 in each of all the ports 400A to 400H and 400Z through the port-table update bus.

The port-table update processing part 403 updates the processing function information stored in the port table 401 if the data processing performed by each device is changed.

For example, if the port-table update processing part 403 in the port 400A receives the port number P1 of the port 400A and “0” as the failure information through the port-table update bus, the port-table update processing part 403 changes the failure information corresponding to the port number P1 stored in the port table 401 from “1” to “0” (refer to FIG. 15A). The change is performed to prohibit transmission of a data packet to the device 200A while the processing function of the device 200A is being changed.

Next, the port-table update processing part 403 receives the port number P1 of the port 400A and the processing function information “No. 2” identifying the encoding processing through the port-table update bus and updates the processing function information corresponding to the port number P1 stored in the port table 401 from the “No. 1” identifying the encryption processing to the “No. 2” identifying the encoding processing (refer to FIG. 15B).

Then, the port-table update processing part 403 receives the port number P1 of the port 400A and “1” as the failure information through the port-table update bus and changes the failure information corresponding to the port number P1 stored in the port table 401 from “0” to “1” (refer to FIG. 15C). The change is performed to clear the prohibition of transmission of a data packet to the device 200A.

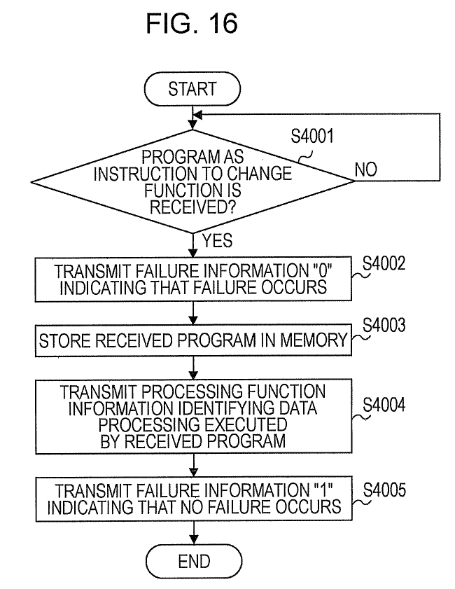

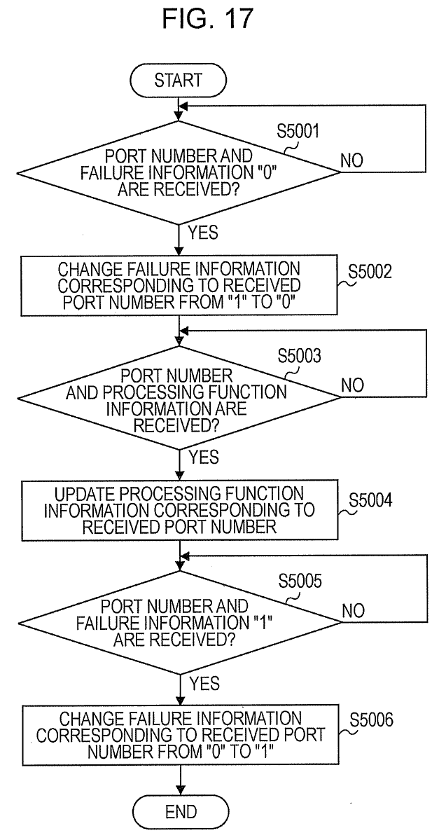

An exemplary process performed by the data processing apparatus according to an embodiment is described. Function changing processes performed by a data processing apparatus according to an embodiment are described here with reference to FIGS. 16 and 17.

FIG. 16 is an operation chart illustrated as an example of a process performed by a device in an embodiment. FIG. 17 is an operation chart illustrated as an example of a process performed by a port in an embodiment.

Referring to FIG. 16, at S4001, the device 200, for example, determines whether a program as an instruction to change a function is received. If the device 200 determines that a program as an instruction to change a program is received (YES at S4001), then at S4002, the device 200 transmits “0” as the failure information indicating that a failure occurs to the port 400 corresponding to the device 200. At S4003, the device 200 deletes the program previously stored in the memory and stores the received program in the memory.

At S4004, the processing-function changing part 210 in the device 200 transmits the processing function information identifying the data processing executed by the received program to the port 400 corresponding to the device 200. At S4005, the processing-function changing part 210 transmits “1” as the failure information indicating that no failure occurs to the port 400 corresponding to the device 200. Then, the function changing process is terminated.

Referring to FIG. 17, at S5001, the port 400, for example, determines whether the port number and “0” as the failure information are received from the device 200. If the port 400 determines that the port number and “0” as the failure information are received from the device 200 (YES at S5001), then at S5002, the port 400 changes the failure information corresponding to the received port number from “1” to “0”.

At S5003, the port 400, for example, determines whether the port number and the processing function information identifying the processing function subjected to the change are received. If the port 400 determines that the port number and the processing function information identifying the processing function subjected to the change are received (YES at S5003), then at S5004, the port 400 updates the processing function information corresponding to the received port number.

At S5005, the port 400, for example, determines whether the port number and “1” as the failure information are received from the device 200. If the port 400 determines that the port number and “1” as the failure information are received from the device 200 (YES at S5005), then at S5006, the port 400 changes the failure information corresponding to the received port number from “0” to “1”. Then, the function changing process is terminated.

As described above, according to an embodiment of the present invention, the data processing apparatus capable of changing the processing function allocated to each device during the operation of the data processing apparatus is applicable to the present invention.

### Fourth Embodiment

If the devices 200 to which substantially the same processing function is allocated have a lighter processing load, supply of power to any of the devices 200 to which substantially the same processing function is allocated may be stopped.

According to an embodiment of the data processing apparatus, a case is described in which the number of devices 200 performing the data processing is varied in accordance with the processing load on the device 200 to reduce the power consumption. An example of the configuration of the data processing apparatus according to an embodiment of the present invention, an exemplary process performed by the data processing apparatus according to an embodiment, and the advantages thereof are sequentially described below.

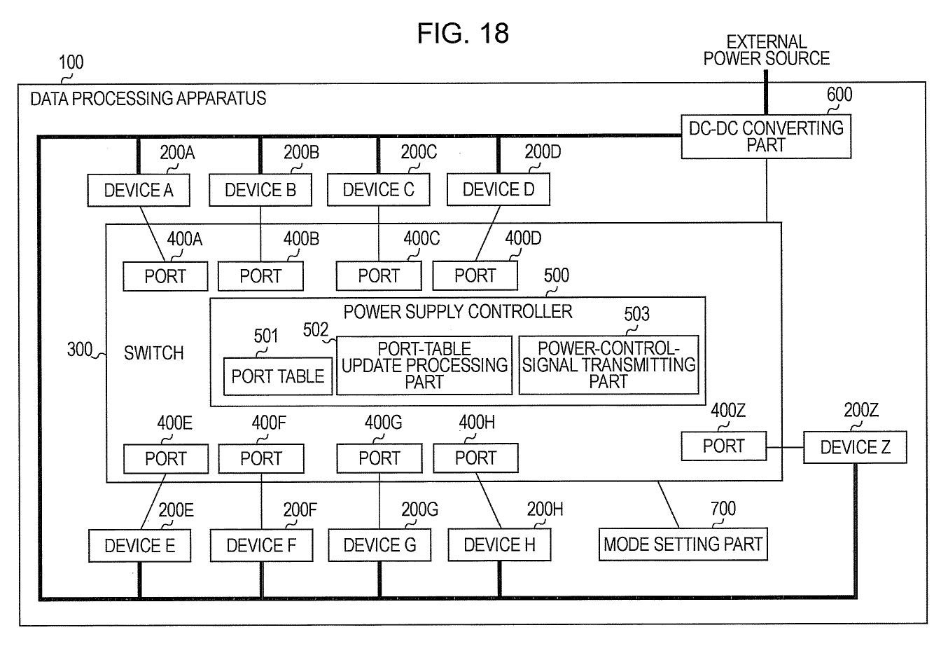

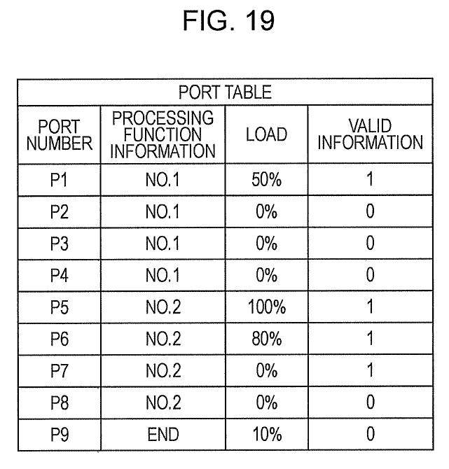

An example of the configuration of the data processing apparatus according to an embodiment is described with reference to FIGS. 18 and 19. FIG. 18 is a block diagram illustrating an example of a configuration of a data processing apparatus according to an embodiment. FIG. 19 illustrates an example of information stored in a port table in an embodiment.

The data processing apparatus 100 according to an embodiment includes substantially the same components as in the data processing apparatus 100 according to an embodiment except that the data processing apparatus 100 according to an embodiment includes a power supply controller 500 in the switch 300 a DC-DC converting part 600, and a mode setting part 700. The configuration of the data processing apparatus 100 according to an embodiment differs from that of the data processing apparatus 100 according to an embodiment in the following manner.

The mode setting part 700 receives a control-state selection instruction to select either of control state(s) of the data processing apparatus 100 from a user. The control states includes a uniform load distribution state in which the load on the data processing is distributed between the multiple devices 200 and a concentrated load distribution state in which the number of devices 200 performing the data processing is decreased to reduce wasteful power consumption. The mode setting part 700 sets either of the uniform load distribution state and the centralized load distribution state in the port selection processing parts 404 in all the ports 400 in accordance with the control-state selection instruction received from the user.

The port table 401 stores valid information identifying the presence of supply of power in association with the port number. For example, the port table 401 stores the processing function information, the load, and the valid information indicating whether power is being supplied in association with the port number of the port 400 corresponding to the device 200, as illustrated in FIG. 19. valid information “1” indicates that the corresponding device 200 is receiving the power supply and is capable of performing the data processing. The valid information “0” indicates that the corresponding device 200 is not receiving the power supply and is not capable of performing the data processing.

In the uniform load distribution state, at reception of data from the device 200, the port selection processing part 404 refers to the port table 401 to select the port number corresponding to the device 200 having the lowest load from among the port numbers to which the processing function information added to the received data is allocated and relays the data to the device 200 corresponding to the port 400 having the selected port number.

In the concentrated load distribution state, the port selection processing part 404 selects the port number corresponding to the device 200 having the highest load from among the port numbers corresponding to the devices 200 capable of performing the data processing and relays the data to the device 200 corresponding to the port 400 having the selected port number. For example, when the port selection processing part 404 receives a data packet, the port selection processing part 404 reads out the processing function information added to the data subjected to the reception processing.

Next, the port selection processing part 404 refers to the port table 401 to select the port numbers that correspond to the readout processing function information and that correspond to the valid information “1”. Then, the port selection processing part 404 selects the port number whose load does not reach 100% and which corresponds to the device 200 having the highest load from among the selected port numbers. The port selection processing part 404 relays the data to the device 200 corresponding to the selected port number.

The power supply controller 500 includes a port table 501, a port-table update processing part 502, and a power-control-signal transmitting part 503. The port table 501 has substantially the same configuration as that of the port table 401 described above. The information stored in the port table 501 is updated in synchronization with the information stored in the port table 401 in the port 400.

The port-table update processing part 502 updates the valid information in accordance with the operational status of the device 200. For example, if the load of the port number P1 corresponding to the device 200A is higher than a given power-supply start threshold value (for example, 60%), the port-table update processing part 502 updates the valid information about the port number P2 corresponding to the device 200B from “0” to “1”. The port number whose port number is updated may be selected by the round robin method or in ascending order of the port numbers.

In contrast, if the load of the port number P1 corresponding to the device 200A is lower than a given power-supply stop threshold value (for example, 40%), the port-table update processing part 502 updates the valid information about the port number P2 corresponding to the device 200B from “1” to “0”.

When the valid information in the port table 501 is updated by the port-table update processing part 502, the power-control-signal transmitting part 503 transmits the port number corresponding to the updated valid information and a power control signal including the content of the update of the Valid information to the DC-DC converting part 600. For example, if the valid information corresponding to the port number P2 is updated from “0” to “1” by the port-table update processing part 502, the power-control-signal transmitting part 503 transmits the port number P2 and the power control signal including the valid information “1” to the DC-DC converting part 600. If the valid information corresponding to the port number P2 is updated from “1” to “0” by the port-table update processing part 502, the power-control-signal transmitting part 503 transmits the port number P2 and the power control signal including the valid information “0” to the DC-DC converting part 600.

The DC-DC converting part 600 controls the supply of power to the device 200. For example, if the DC-DC converting part 600 receives the port number P2 and the power control signal including the valid information “1” from the power-control-signal transmitting part 503, the DC-DC converting part 600 starts the supply of power to the device 200B corresponding to the port number P2. If the DC-DC converting part 600 receives the port number P2 and the power control signal including the valid information “0” from the power-control-signal transmitting part 503, the DC-DC converting part 600 stops the supply of power to the device 200B corresponding to the port number P2.

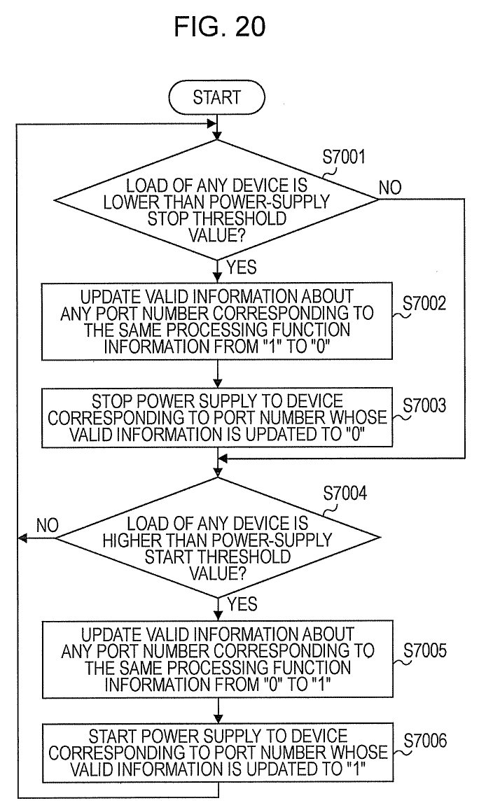

An exemplary process performed by the data processing apparatus according to an embodiment is described with reference to FIG. 20. A process performed by the power supply controller 500 and the DC-DC converting part 600 when the control-state selection instruction to select the concentrated load distribution state is received from the user will be described. The process described here is terminated when the operation of the data processing apparatus is stopped. FIG. 20 is an operation chart illustrated as an example of a process performed by the data processing apparatus according to an embodiment.

Referring to FIG. 20, in Operation S7001, the port-table update processing part 502, for example, determines whether the load of the port number corresponding to any of the devices 200 is lower than the power-supply stop threshold value. If the port-table update processing part 502 determines that the load of the port number corresponding to any of the devices 200 is lower than the power-supply stop threshold value (YES at S7001), then at S7002, the port-table update processing part 502 updates the Valid information about any of the port numbers corresponding to the substantially same processing function information as that of the port number whose load is lower than the power-supply stop threshold value from “1” to “0”. If the port-table update processing part 502 determines that the load of the port number corresponding to any of the devices 200 is not lower than the power-supply stop threshold value (NO at S7001), the process goes to S7004. At S7003, the DC-DC converting part 600 stops the supply of power to the device corresponding to the port, number whose Valid information is updated to “0”. The power-supply stop threshold value and/or the power-supply start threshold value of the present invention may not be limited to any particular value. For example, a threshold value may be varied in accordance with a time and/or a condition including season related information.

At S7004, the port-table update processing part 502 determines whether the load of the port number corresponding to any of the devices 200 is higher than the power-supply start threshold value. If the port-table update processing part 502 determines that the load of the port number corresponding to any of the devices 200 is higher than the power-supply start threshold value (YES at S7004), then at S7005, the port-table update processing part 502 updates the valid information about any of the port numbers corresponding to substantially the same processing function information as that of the port number whose load is higher than the power-supply start threshold value from “0” to “1”. If the port-table update processing part 502 determines that the load of the port number corresponding to any of the devices 200 is not higher than the power-supply start threshold value (NO at S7004), the process goes back to S7001. At S7006, the DC-DC converting part 600 starts the supply of power to the device corresponding to the port number whose valid information is updated to “1”. Then, the process goes back to S7001.

As described above, according to an embodiment of the present invention, since a number of devices to which power is supplied can be decreased if each device to which substantially the same processing function is allocated has a lighter processing load, it is possible to reduce wasteful power consumption.

According to the above-identified embodiments, it is possible to easily balance the processing load between the multiple devices by using the port table, compared with technologies for balancing the processing load between multiple devices in the related art. Such technologies are discussed in, for example, Japanese Unexamined Patent Application Publication Nos. 2005-4757, 2001-251664, and 1996-161274.

### Other Embodiments

Various embodiments of the data processing apparatus may be realized in, in addition to the embodiments described above.

For example, when certain data processing is completed, a component other than the device 200 may select one device from among multiple devices capable of performing data processing to be performed subsequent to the certain data processing.

For example, although each port 400 includes the port table 401 in the data processing apparatuses 100 according to the above-identified embodiments, the port table 401 may be shared between the ports 400.

Although the load-state measuring part 201 and the load-state transmitting part 202 are included in the device 200 in the data processing apparatus 100 according to an embodiment, an MPU (a processor for monitoring) notifying the port 400 of the state of the load of each device may be provided as a component separated from the device 200.

The process(es), the control process(es), the specific name(s), and the information including the variety of data and various parameter(s) illustrated in the specification and the drawings (for example, the information illustrated in FIGS. 1, 6, 11, 15A, 15B, 15C, and 19 and the structure of the data packet illustrated in FIGS. 4A, 4B, and 4C) may be arbitrarily varied, unless otherwise specified.

The components in each apparatus and device illustrated in the drawings are functional and conceptual components and may not be physically configured in the manner illustrated in the drawings. In other words, the specific modes of separation and integration of the apparatuses and devices are not restricted to the ones illustrated in the drawings and all or part of the modes may be functionally or physically separated or integrated in arbitrary units in accordance with various loads or the usage. For example, the data receiving part 203 and the data transmitting part 207 illustrated in FIG. 3 may be integrated with each other.

All or part of the processing functions performed by each apparatus and device may be realized by the CPU and the program(s) analyzed and executed by the CPU or may be realized by a wired logic as hardware.

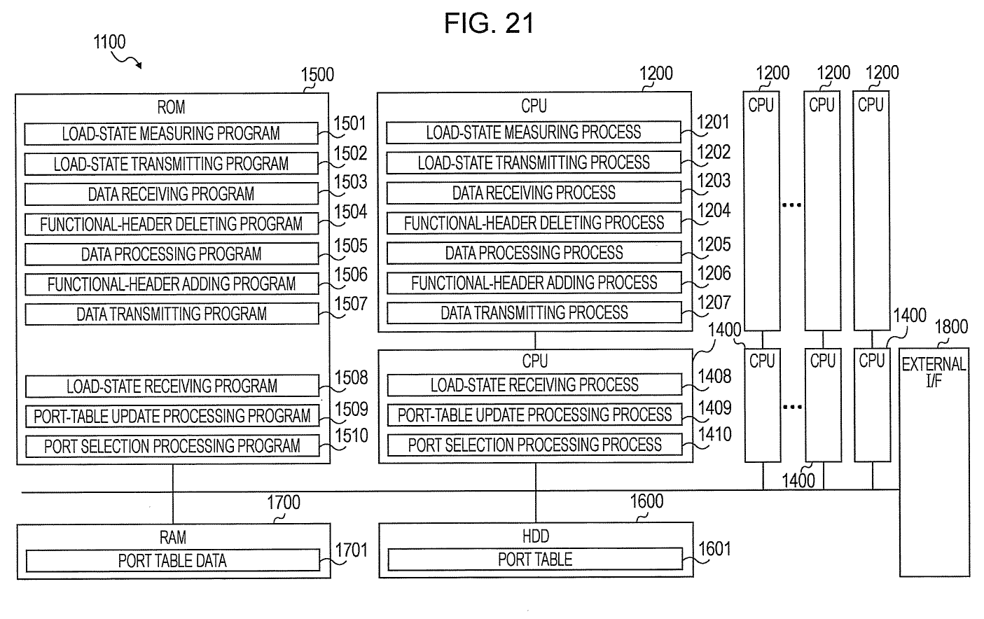

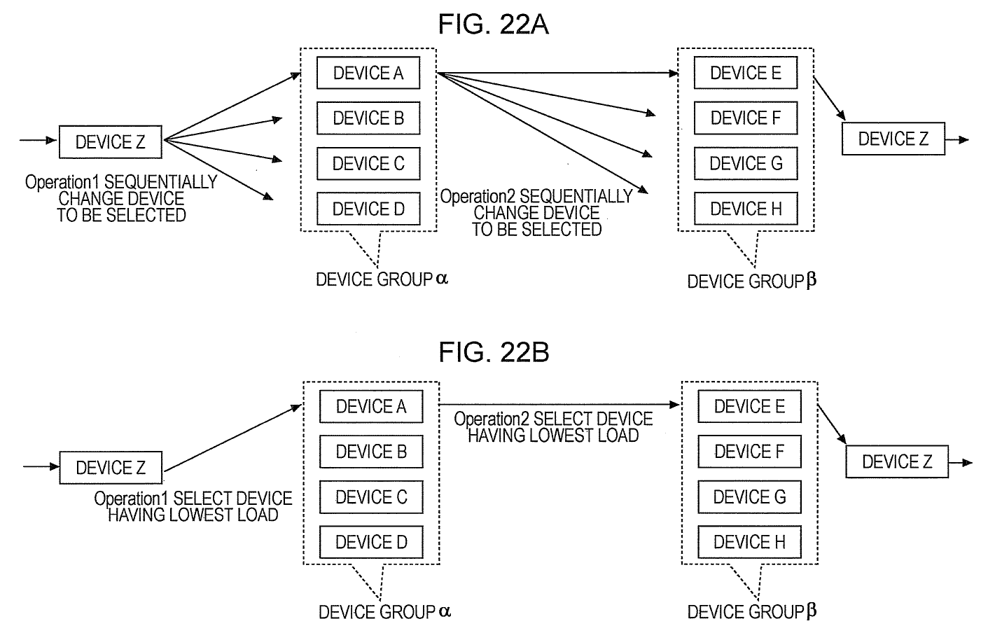

An embodiment of the data processing apparatus may be realized by a computer serving as the data processing apparatus 100, which executes programs prepared in advance. An example of a computer executing a data processing program having substantially the same functions as those of the data processing apparatuses 100 according to the above embodiments will now be described with reference to FIG. 21. FIG. 21 illustrates an example of a configuration of a computer executing a data processing program.

Referring to FIG. 21, a computer 1100 serving as the data processing apparatus 100 includes CPUs 1200 each serving as the device 200, CPUs 1400 each serving as the port 400, a read only memory (ROM) 1500, a hard disk drive (HDD) 1600, a random access memory (RAM) 1700, and an external interface 1800, which are connected to each other via, for example, a bus.

The ROM 1500 stores programs having substantially the same functions as those of the device 200 in an embodiment. For example, the ROM 1500 stores a load-state measuring program 1501, a load-state transmitting program 1502, a data receiving program 1503, a functional-header deleting program 1504, a data processing program 1505 (for example, an encryption processing program), a functional-header adding program 1506, and a data transmitting program 1507, as illustrated in FIG. 21. The ROM 1500 also stores programs having substantially the same function(s) as those of the port 400 in an embodiment. For example, the ROM 1500 also stores a load-state receiving program 1508, a port-table update processing program 1509, and a port selection processing program 1510. The programs from the load-state measuring program 1501 to the port selection processing program 1510 may be appropriately integrated or separated, as in the components in the data processing apparatus 100 illustrated in FIGS. 3 and 5.

Each CPU 1200 reads out the programs from the load-state measuring program 1501 to the data transmitting program 1507 from the ROM 1500 and executes the readout programs to cause the programs from the load-state measuring program 1501 to the data transmitting program 1507 to function as a load-state measuring process 1201, a load-state transmitting process 1202, a data receiving process 1203, a functional-header deleting process 1204, a data processing process 1205, a functional-header adding process 1206, and a data transmitting process 1207, as illustrated in FIG. 21.

Each CPU 1400 reads out the programs from the load-state receiving program 1508 to the port selection processing program 1510 from the ROM 1500 and executes the readout programs to cause the programs from the load-state receiving program 1508 to the port selection processing program 1510 to function as a load-state receiving process 1408, a port-table update processing process 1409, and a port selection processing process 1410, as illustrated in FIG. 21.

The processes from the load-state measuring process 1201 to the data transmitting process 1207 correspond to the load-state measuring part 201, the load-state transmitting part 202, the data receiving part 203, the functional-header deleting part 204, the data processing part 205, the functional-header adding part 206, and the data transmitting part 207, respectively, as illustrated in FIG. 3. The processes from the load-state receiving process 1408 to the port selection processing process 1410 correspond to the load-state receiving part 402, the port-table update processing part 403, and the port selection processing part 404, respectively, illustrated in FIG. 5.

The HDD 1600 includes a port table 1601, as illustrated in FIG. 21. The CPU 1200 reads out the port table 1601 from the HDD 1600 to store the readout port table 1601 in the RAM 1700 and performs processing on the basis of port table data 1701 stored in the RAM 1700. The port table 401 is provided in each port 400 in the example illustrated in FIG. 5 whereas each CPU 1400 performs the processing on the basis of the port table data 1701 shared between the CPUs 1400 in the example illustrated in FIG. 21. The port table data 1701 corresponds to the port table 401 illustrated in FIG. 5.

The programs from the load-state measuring program 1501 to the port selection processing program 1510 may not be preferably stored in the ROM 1500. For example, the programs may be stored in a “portable physical medium”, such as a flexible disk (FD), a compact disk-read only memory (CD-ROM), a digital versatile disk (DVD), a magneto-optical disk, or an integrated circuit (IC) card, which is loaded in the computer 1100, a “fixed physical medium”, such as an HDD, which is provided in or outside the computer 1100, or “another computer (or server)” connected to the computer 1100 via a public switched network, the Internet, a local area network (LAN), or a wide area network (WAN). The computer 1100 reads out each program and executes the readout program.

All examples and conditional language recited herein are intended for pedagogical purposes to aid the reader in understanding the invention and the concepts contributed by the inventor to furthering the art, and are to be construed as being without limitation to such For example recited examples and conditions, nor does the organization of such examples in the specification relate to a showing of the superiority and inferiority of the invention. Although the embodiments of the present inventions have been described in detail, it may be understood that the various changes, substitutions, and alterations could be made hereto without departing from the spirit and scope of the invention and the scope of which is defined in the claims and their equivalents.

1. A data processing apparatus including a plurality of devices and a switch which includes each of a plurality of ports connecting to each of the plurality of devices, the data processing apparatus comprising:
a data processing part in each of the plurality of devices performing a data processing in a given order;
a switching part in the switch, including:
a data transmitting-receiving part receiving data with processing function information identifying a data processing to be subsequently performed from another data processing apparatus, transmitting data or receiving data to or from one of the devices via a corresponding port, and transmitting processed data to the other data processing apparatus,
a port table storing processing function information for identifying a data processing performed by each device corresponding to each port and a load state that is updated in accordance with an operational status of each device corresponding to each port in association with a port number identifying each port, and
a data relaying part referring to the port table at reception of data from one of the devices to select a port number corresponding to a device having a lowest load from among the port numbers to which the processing function information added to the received data is allocated and relaying the data to the device corresponding to the port having the selected port number; and
each processing function part in the plurality of the devices, including:
a data processing part performing data processing to the relayed data in the given order according to the processing function information,
a functional-header adding part adding processing function information to the processed data, and
a data transmitting part transmitting the data with the processing function information.

2. The data processing apparatus according to claim 1,
wherein the port table further stores failure information identifying a device where a failure occurs in association with the port number, and
the data relaying part selects the port number that does not correspond to the failure information and corresponds to the device having the lowest load from among the port numbers stored in the port table.

3. The data processing apparatus according to claim 2, wherein the data transmitting-receiving part further includes:
a processing-function-information updating part that updates the processing function information stored in the port table when the data processing performed by each processing function part is changed.

4. The data processing apparatus according to claim 1, the apparatus further comprising:
a power-supply controlling part monitoring the port table to determine whether a load corresponding to any device is lower than a given power-supply stop threshold value or a load corresponding to any device is higher than a given power-supply start threshold value,
the power-supply controlling part stopping a supply of power to a device among the devices performing substantially the same data processing as that of a device whose load is lower than the power-supply stop threshold value when determining that the load corresponding to any device is lower than the power-supply stop threshold value, and
the power-supply controlling part starting supply of power to a device among the devices performing substantially the same data processing as that of the device whose load is higher than the power-supply start threshold value when determining that the load corresponding to any device is higher than the power-supply start threshold value,
wherein the port table stores power supply information identifying the device to which the power is being supplied in association with the port number, and
the data relaying part selects the port number corresponding to the power supply information from among the port numbers stored in the port table.

5. The data processing apparatus according to claim 2, the apparatus further comprising:
a power-supply controlling part that monitors the port table to determine whether the load corresponding to any device is lower than a given power-supply stop threshold value or the load corresponding to any device is higher than a given power-supply start threshold value,
the power-supply controlling part stopping supply of power to a device among the devices performing substantially the same data processing as that of a device whose load is lower than the power-supply stop threshold value when determining that the load corresponding to any device is lower than the power-supply stop threshold value,
the power-supply controlling part starting supply of power to a device among the devices performing substantially the same data processing as that of a device whose load is higher than the power-supply start threshold value when determining that the load corresponding to any device is higher than the power-supply start threshold value,
wherein the port table stores power supply information identifying the device to which the power is being supplied in association with the port number, and
the data relaying part selects the port number corresponding to the power supply information from among the port numbers stored in the port table.

6. The data processing apparatus according to claim 3, the apparatus further comprising:
a power-supply controlling part that monitors the port table to determine whether the load corresponding to any device is lower than a given power-supply stop threshold value or the load corresponding to any device is higher than a given power-supply start threshold value,
the power-supply controlling part stopping supply of power to a device among the devices performing substantially the same data processing as that of a device whose load is lower than the power-supply stop threshold value when determining that the load corresponding to any device is lower than the power-supply stop threshold value, and
the power-supply controlling part starting supply of power to a device among the devices performing substantially the same data processing as that of a device whose load is higher than the power-supply start threshold value when determining that the load corresponding to any device is higher than the power-supply start threshold value,
wherein the port table stores power supply information identifying the device to which the power is being supplied in association with the port number, and
the data relaying part selects the port number corresponding to the power supply information from among the port numbers stored in the port table.

7. The data processing apparatus according to claim 4, the apparatus further comprising:
a control-state selection instruction receiving part that receives from a user a control-state selection instruction to select either of a uniform load distribution state in which a load on the data processing is distributed between the plurality of devices and a concentrated load distribution state in which a number of devices performing the data processing is decreased to reduce wasteful power consumption,
wherein, when the control-state selection instruction receiving part receives the control-state selection instruction to select the uniform load distribution state from the user, the data relaying part refers to the port table at reception of data from one of the devices to select the port number corresponding to the device having the lowest load from among the port numbers to which the processing function information added to the received data is allocated and relays the data to the device corresponding to the port having the selected port number, and
when the control-state selection instruction receiving part receives the control-state selection instruction to select the concentrated load distribution state from the user, the data relaying part refers to the port table at reception of data from one of the devices to select the port number corresponding to the device having a highest load from among the port numbers to which the processing function information added to the received data is allocated and which correspond to the power supply information and relays the data to the device corresponding to the port having the selected port number.

8. The data processing apparatus according to claim 5, the apparatus further comprising:
a control-state selection instruction receiving part that receives from a user a control-state selection instruction to select either of a uniform load distribution state in which a load on the data processing is distributed between the plurality of devices and a concentrated load distribution state in which a number of devices performing the data processing is decreased to reduce wasteful power consumption,
wherein, when the control-state selection instruction receiving part receives the control-state selection instruction to select the uniform load distribution state from the user, the data relaying part refers to the port table at reception of data from one of the devices to select the port number corresponding to the device having the lowest load from among the port numbers to which the processing function information added to the received data is allocated and relays the data to the device corresponding to the port having the selected port number, and
when the control-state selection instruction receiving part receives the control-state selection instruction to select the concentrated load distribution state from the user, the data relaying part refers to the port table at reception of data from one of the devices to select the port number corresponding to the device having a highest load from among the port numbers to which the processing function information added to the received data is allocated and which correspond to the power supply information and relays the data to the device corresponding to the port having the selected port number.

9. The data processing apparatus according to claim 6, the apparatus further comprising:
a control-state selection instruction receiving part that receives from a user a control-state selection instruction to select either of a uniform load distribution state in which a load on the data processing is distributed between the plurality of devices and a concentrated load distribution state in which a number of devices performing the data processing is decreased to reduce wasteful power consumption,
wherein, when the control-state selection instruction receiving part receives the control-state selection instruction to select the uniform load distribution state from the user, the data relaying part refers to the port table at reception of data from one of the devices to select the port number corresponding to the device having the lowest load from among the port numbers to which the processing function information added to the received data is allocated and relays the data to the device corresponding to the port having the selected port number, and
when the control-state selection instruction receiving part receives the control-state selection instruction to select the concentrated load distribution state from the user, the data relaying part refers to the port table at reception of data from one of the devices to select the port number corresponding to the device having a highest load from among the port numbers to which the processing function information added to the received data is allocated and which correspond to the power supply information and relays the data to the device corresponding to the port having the selected port number.

10. The data processing apparatus according to claim 4, the apparatus further comprising:
a threshold-value varying part that varies the power-supply stop threshold value and/or the power-supply start threshold value in accordance with a time and/or a condition including a season.

11. The data processing apparatus according to claim 5, the apparatus further comprising:
a threshold-value varying part that varies the power-supply stop threshold value and/or the power-supply start threshold value in accordance with a time and/or a season.

12. The data processing apparatus according to claim 6, the apparatus further comprising:
a threshold-value varying part that varies the power-supply stop threshold value and/or the power-supply start threshold value in accordance with a time and/or a condition including a season.

13. The data processing apparatus according to claim 7, the apparatus further comprising:
a threshold-value varying part that varies the power-supply stop threshold value and/or the power-supply start threshold value in accordance with a time and/or a condition including a season.

14. The data processing apparatus according to claim 8, the apparatus further comprising:
a threshold-value varying part that varies the power-supply stop threshold value and/or the power-supply start threshold value in accordance with a time and/or a condition including a season.

15. The data processing apparatus according to claim 9, the apparatus further comprising:
a threshold-value varying part that varies the power-supply stop threshold value and/or the power-supply start threshold value in accordance with a time and/or a condition including a season.

16. A data processing method for causing a computer to function as a data processing apparatus including a plurality of devices, a switching part in a switch which includes each of a plurality of ports connecting to each of a plurality of devices, a data transmitting-receiving part, and the plurality of devices performing data processing in a given order, the data processing method comprising the operations of:
storing a port table that includes processing function information for identifying a data processing performed by each device corresponding to each port and a load state that is updated in accordance with an operational status of each device corresponding to each port in association with a port number identifying each port;
referring to the port table at reception of data from one of the devices to select a port number corresponding to a device having a lowest load from among the port numbers to which the processing function information added to the received data is allocated and relaying the data to the device corresponding to the port having the selected port number; and
performing the data processing to the data relayed in a given order according to the processing function information, adding the processing function information identifying the data processing to be subsequently performed to the processed data, and transmitting the data to which the processing function information is added.

17. A computer-readable recording medium that stores a data processing program for causing a plurality of devices in a computer to function as a data processing apparatus including a plurality of devices to perform data processing in a given order, a switching part in a switch which includes each of a plurality of ports connecting to each of a plurality of devices, the data processing program make the computer execute:
storing a port table that includes processing function information identifying the data processing performed by the device corresponding to each port and a load state that is updated in accordance with the operational status of the device corresponding to each port in association with a port number identifying each port;
referring to the port table at reception of data from one of the devices to select the port number corresponding to the device having a lowest load from among the port numbers to which the processing function information added to the received data is allocated and relaying the data to the device corresponding to the port having the selected port number; and
performing the data processing to the data relayed in a given order according to the processing function information, adding the processing function information for identifying the data processing to be subsequently performed to the processed data, and transmitting the data to which the processing function information is added.

18. A data processing method, comprising:
storing a port table identifying each port and a load state thereof;
selecting a port number from the port table corresponding to a device having a lowest load from among ports indicating a common processing to be subsequently performed to received data; and
relaying the data to the device having the selected port number.

19. The method according to claim 18, wherein said selecting is performed such that the port number does not correspond to a port identified in failure information and based on a given power-supply stop threshold value.
